(19) United States
(12) Patent Application Publication
(10) Pub. No.: US 2008/0271585 A1
(43) Pub. Date: Nov. 6, 2008

(54) APPARATUS AND METHOD FOR TEACHING THE PLAYING OF A STRINGED INSTRUMENT

(76) Inventor: Pearl R. Jones, Sterling Heights, MI (US)

Correspondence Address: GREGORY T. ZALECKI, 12900 HALL ROAD, SUITE 400, STERLING HEIGHTS, MI, 48313, US

(21) Appl. No.: 11/744,838

(22) Filed: May 5, 2007

(51) Int. Cl. G10D 1/02; G10D 3/18

(52) U.S. Cl. 84/281; 84/328

(57) ABSTRACT

An apparatus for teaching the playing of an unfretted stringed instrument, such as a violin or viola, is comprised of a clip and a guide member. The clip is adapted to be releasably attachable to the neck of the instrument near its body. The guide member extends from the clip. The guide member is sized, shaped and positioned to require the player to maintain a substantially straight hand, arm and wrist alignment when playing the instrument. If the player's string hand and wrist are improperly bent while playing the instrument, the player will feel interference from the apparatus. The apparatus is used to teach proper hand, finger, wrist and arm alignment to a student.

### BACKGROUND

This invention relates to an apparatus and a method for teaching the playing of an unfretted stringed instrument. The most common unfretted stringed instruments are violins, violas, cellos and bass instruments. The apparatus is primarily intended for use upon a violin or a viola.

Violins and violas are musical instruments. Their use is very popular within orchestras and bands. This popularity is due in large part to the unique and pleasing tones which the instruments produce.

Violins and violas are similarly constructed. They consist of a neck attached to a body. A fingerboard overlies the neck. Strings extend from one end of the neck (referred to as the pegbox or scroll) over a raised surface referred to as a nut and across a bridge located on the body. In order to play the instrument the musician's fingers are used to depress the strings, while a bow is drawn across the strings to induce vibrations within the strings, thus producing music.

Learning to play a violin or a viola requires many hours of practice. The player must be able to depress only one string at a time. The string must be depressed in the proper location. Although the player's hand can be placed at numerous positions along the neck of the instrument, the most common position used by learners is called the first position. One set of notes may be played from the first position while the player's hand remains in the same position relative to the neck of the instrument.

In order to properly play the instrument a very important skill must be mastered. This skill is the proper placement and positioning of the string hand, arm and wrist of the player. Proper positioning allows the strings to be properly depressed. The most important feature of proper positioning is a straight alignment of the player's string hand, lower arm and wrist. The wrist must not be bent. It is important that the player's lower palm and wrist not touch the instrument body or instrument neck near the body. The lower arm attached to the string hand should be under the instrument and not off to the player's left side.

Many beginning violin and viola players make a common mistake. They bend their string hand palm and wrist under the neck of the instrument. They may even contact the instrument body with their string hand. They fail to maintain a straight alignment of the string hand, lower arm and wrist. As a result, the instrument is not properly played. What is needed is a device which attaches to the neck of the instrument. The device would prevent improper hand, arm and wrist positioning. This would shorten the time needed to become a proficient violin or viola player.

### SUMMARY

This need is satisfied by the apparatus for teaching the playing of a stringed instrument described herein. The apparatus is comprised of a clip and a guide member.

The clip is sized and shaped to be attachable to a portion of the instrument neck near the instrument body. The clip is intended to be attached to the underside of the neck. The clip should be releasably attachable to the neck. This will allow the apparatus to be easily installed and removed. Many instruments will not fit within their respective cases with the device attached.

Preferably, the clip is generally cylindrical in shape with a cutout extending along the length of the clip. The cutout allows the clip to be received by the neck of the instrument. The clip has a body end. The body end of the clip is the end of the clip which is nearest to the body when the apparatus is attached to the neck. The width of the cutout near the body end of the clip should be narrower than the width of the cutout at the other end of the clip. This will permit the clip to surround a portion of the instrument neck and fingerboard delimited by the fingerboard when the clip is attached to the neck because the cross-sectional area of the neck of most instruments increases in the direction from the scroll to body. When installed, the clip does not extend above the fingerboard. In other words, the portion of the instrument neck and fingerboard which is surrounded by the clip is delimited by the fingerboard such that the clip does not extend above the fingerboard. If the clip extended above the fingerboard, the extended portion of the clip may interfere with the ability of the player to properly depress the strings.

The guide member extends from the clip. The guide member is sized, shaped and positioned to position the string hand, arm and wrist of the instrument player such that the string hand, arm and wrist are substantially straight and such that the string hand, arm and wrist avoid contact with the instrument body and the portion of the instrument neck near the instrument body when the fingers of the player's string hand are positioned for playing the instrument by depressing one or more strings. For most learners the position of the hand and fingers relative to the instrument neck will be in the first position for playing the instrument. The term first position has a specific meaning to most proficient violin players. The guide member should be generally radiused toward the body of the instrument when the clip is attached to the neck of the instrument. The radius should be such that the guide member substantially fits the palm of the string hand of the player when the fingers of the string hand of the player are positioned upon one or more strings of the instrument.

The guide member may be extended from the clip by a strut. In the preferred embodiment, the angle between the strut and the longitudinal section of the clip to which the strut is attached is an acute angle. Also, an acute angle should be formed between the longitudinal axis of the strut and a plane perpendicular to the body of the instrument through the longitudinal axis of the instrument neck. This strut angle is defined on the side of the plane distal to the player's chin when the instrument is being played by the player.

The apparatus may be used to teach a student how to play an unfretted stringed instrument (such as a violin or a viola) having a neck connected to a body, a fingerboard overlaying the neck and body, and strings extending along the fingerboard. First an apparatus as described previously is selected. The apparatus is attached to the neck of the instrument such that the string hand, arm and wrist of the instrument player are substantially straight and such that the string hand, arm and wrist avoid contact with the instrument body and the portion of the instrument neck near the instrument body when the fingers of the player's string hand are positioned for playing the instrument by depressing one or more strings from the first position for playing the instrument. The student is advised as to the correct finger, hand, wrist and arm positioning when playing the instrument. The student is also advised as to the incorrect finger, hand, wrist and arm positioning when playing the instrument. The correct positioning is one wherein the string hand, arm and wrist of the player are substantially straight, while the incorrect positioning is one wherein the wrist is bent and the straight alignment of the hand, arm and wrist is absent. The student plays the instrument with the apparatus attached. The student receives tactile feedback from the apparatus when the student uses incorrect finger, hand, wrist or arm positioning while playing the instrument. In other words, the student will feel interference from the apparatus when the student attempts to use incorrect positioning. The apparatus will prevent incorrect positioning of the fingers, hand, wrist and arm.

### DRAWINGS

These and other features, aspects, and advantages of the present invention will become better understood with regard to the following description, appended claims, and accompanying drawings where:

FIG. 1 is a broken away perspective view of a violin without the apparatus attached.

FIG. 2 is a broken away perspective view of the violin of FIG. 1, with the apparatus attached and showing the correct finger, hand, wrist and arm positioning of a player.

FIG. 3 is a top view of the apparatus for teaching the playing of an unfretted stringed instrument shown in FIG. 2.

FIG. 4 is a side view of the apparatus shown in FIG. 2.

FIG. 5 is a perspective view of the apparatus shown in FIG. 2.

FIG. 6 is an end view of the apparatus shown in FIG. 2.

FIG. 7 is an end view of the apparatus shown in FIG. 2 which also shows the neck and fingerboard of the violin shown in FIG. 2.

### DESCRIPTION

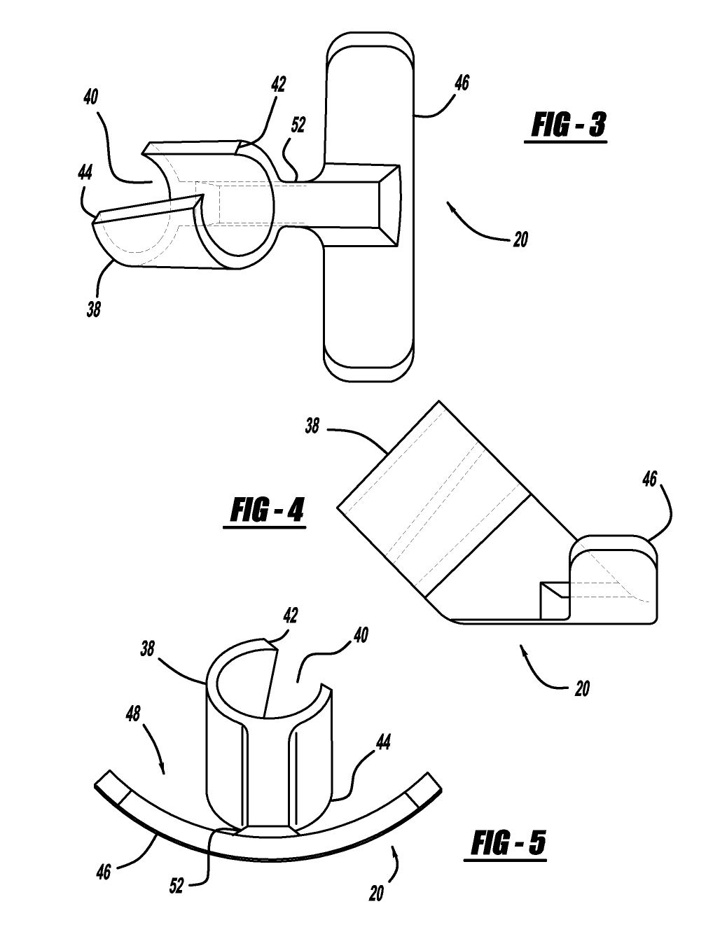

The preferred embodiment of an apparatus 20 for teaching the playing of an unfretted stringed instrument is shown attached to a violin 22 in FIG. 2. Different views of the apparatus 20 are also shown in FIG. 3 through FIG. 7.

A violin 22 is comprised of a body 26, a neck 24, a fingerboard 28 and a plurality of strings 30, as shown in FIG. 2 and FIG. 3. The neck 24 is attached to the body 26 of the violin 22. The fingerboard 28 overlies the neck 24. A violin 22 has four strings 30. The strings 30 extend from one end of the neck 24 (referred to as the pegbox or scroll) over a raised surface referred to as a nut and across a bridge located on the body 26. The violin 22 is played with a bow. The strings 30 are tuned at intervals of a fifth. The fingerboard 28 is unfretted. The violin 22 is capable of great flexibility in range, tone and dynamics. The apparatus 20 for teaching the playing of an unfretted stringed instrument may also be used to teach the playing of a viola 22. A viola 22 is a stringed instrument of the violin family. It is slightly larger than a violin. It is tuned a fifth lower. It has a deeper, more sonorous tone.

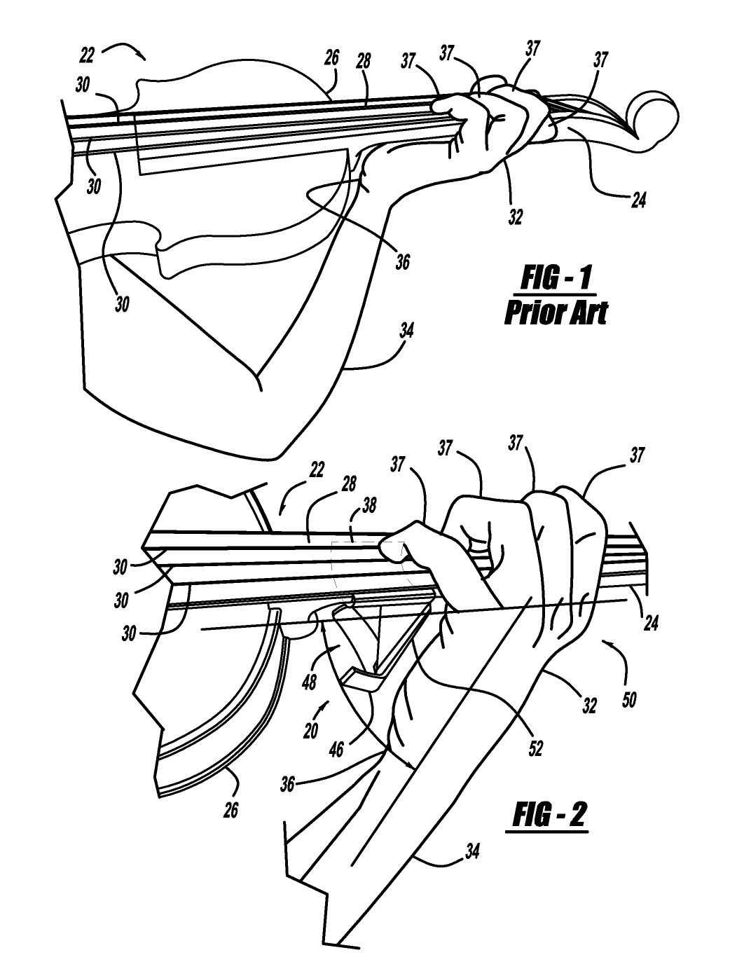

The fingers 37 of the left hand 32 are used to depress the strings 30 of the violin 22. The left hand, arm, wrist and fingers are thus referred to as the string hand 32, the string arm 34, the string wrist 36 and the string fingers 37. The proper placement of the string fingers 37 upon the strings 30 of the violin 22, as well as the associated placement of the string wrist 36, the string arm 34 and the string hand 32, is illustrated within FIG. 2. Note that the string hand 32, arm 34 and wrist 36 are aligned so that they are substantially straight. Also note that the string hand 32, arm 34 and wrist 36 avoid contact with the instrument body 26 and the portion of the instrument neck near the instrument body 26. If the wrist 36 were bent so that the lower end of the palm of the hand 32 contacted the neck 24 of the instrument 22 near the body 26 of the instrument 22 and the palm and the arm 34 formed an angle approximating 90°, this would be illustrative of improper hand 32, arm 34, wrist 36 positioning. Improper positioning is illustrated within FIG. 1. If the string hand 32, string wrist 36 and the string arm 34 are not aligned such that they substantially form a straight line, it will be very difficult, or impossible, for the player to properly depress the strings 30. It will also be very difficult, or impossible, for the player to properly play vibrato tones. Vibrato is a tremulous or pulsating effect produced with the violin 22 by barely perceptible minute and rapid variations in pitch.

FIG. 2 also illustrates the “first position” 50 used for playing a violin 32. The first position 50 is a relative position of the hand 32, thumb and fingers 37 with respect to the neck 24 of the instrument 22. One set of notes may be played from the first position 50 without moving the hand 32 and thumb relative to the neck 24 of the instrument 22. Beginning student violinists are typically instructed to play from the first position 50. A felt marker may be attached to the neck 24 of the instrument 22 in a position where the marker will be under the thumb of the player's left hand 32 when the hand 32 is properly positioned in the first position 50. The felt marker may be made to be releasably attachable by using an appropriate adhesive for attachment to the neck 24. An enhanced learning experience may be obtained by attaching both a felt marker and the apparatus 20 for teaching the playing of an unfretted stringed instrument to the neck 24 of the instrument 22. When the neck 24 of the instrument 22 is so equipped, it will be much easier for the player/student to learn correct string hand 32 positioning.

The apparatus 20 for teaching the playing of an unfretted stringed instrument, such as a violin 22, is comprised of a clip 38 and a guide member 46. The clip 38 is sized and shaped to be attachable to a portion of the instrument 22 neck 24 near the instrument body 26. In fact, the clip 38 may be permanently attached to the neck 24 of the instrument 22 to form a special-purpose teaching instrument 22. However, it is usually desirable to have the clip 38 be releasably attachable to the neck 24. The clip 38 can then be quickly attached and detached from the neck 24. It can be attached to provide for the learning experience. It can be detached to permit the instrument 22 to be stored within its case. One configuration of the clip 38 which is releasably attachable to the neck 24 of an instrument 22 employs a shape which is generally cylindrical, as shown in FIG. 3. A cutout 40 extends along the length of the clip 38, as also shown in FIG. 3. The purpose of the cutout 40 is to provide an opening through which the neck 24 of the instrument 22 may be received. The clip 38 has a body end 42. The body end 42 is that end of the clip 38 which is proximal to the body 26 of the instrument 22 when the apparatus 20 is attached. The other end 44 of the clip 38 is referred to as the other end 44. The width of the cutout 40 near the body end 42 of the clip 38 should be narrower than the width of the cutout 40 at the other end 44 of the clip 38. The cutout 40 dimensions should be such that the clip 38 will surround a portion of the instrument neck 24 and fingerboard 28 which is delimited by the fingerboard 28 when the clip 38 is attached to a portion of the instrument neck 24 near the instrument body 26, as shown in FIG. 2 and FIG. 7. Thus, no part of the clip 38 will extend above the fingerboard 28. This is what is meant when a portion of the instrument neck 24 and fingerboard 28 delimited by the fingerboard 28 is referred to. If the clip 38 did extend above the fingerboard 28, this would cause interference with the player's fingers 37 while the instrument 22 is being played.

Other clip 38 configurations are within the scope of this invention. The clip 38 may employ a spring-loaded clamp for attaching it to the neck 24. The clip 38 may employ a screw type clamp for attachment to the neck 24. A screw type clamp would use one or more threaded members which would tighten the clip 38 upon the neck 24 when the threaded members are turned in a tightening direction. The clip 38 may be made attachable to the neck 24 by applying a releasable adhesive to the clip 38. A hook and pile system (sold under the trade name VELCRO) may be applied to the clip 38 and neck 24 to render the clip 38 releasably attachable to the neck 24. The clip 38 may surround the neck 24 and fingerboard 28, while remaining below the strings 30 of the instrument 22, in order to provide a more secure attachment to the neck 24. Alternatively, the clip 38 may be permanently attached to the neck 24 of the instrument 22, as previously described.

I have fabricated a prototype apparatus 20 which securely and releasably fastens to the neck 24 of a commonly shaped violin 22. I used PVC tubing having an inside diameter of approximately 0.875 inches. The width of the cutout 40 near the body end 42 was approximately 0.52 inches. The width of the cutout 40 near the other end of the clip 38 was approximately 0.74 inches. The length of the clip 38 was approximately 1.25 inches. Using these dimensions the clip 38 completely surrounded the neck 24 and the fingerboard 28 without extending above the fingerboard 28. A secure, but releasable fit, between the clip 38 and the neck 24 was obtained. I have found that my prototype works well with violins 22 having necks 24 of differing sizes. When the clip 38 is attached to the neck 24 of a violin 22, the body end 42 of the clip surrounds an arc shaped section of the neck 24. The arc begins at one side of the fingerboard 28 and ends at the other side of the fingerboard 28. The arc does not extend above the fingerboard 28 under the optimal design, as previously described. I have found that my prototype works well and releasably secures well to the neck 24 of an instrument 22 when the circumference of the arc is between 5.0 cm and 5.8 cm. This means that that prototype will function as intended on a wide variety of instruments 22. However, it should be clear that my invention is not limited to instruments 22 having necks 24 with the aforementioned arc dimensions. A less costly apparatus 20 may be fabricated by using plastic injection molding to produce the apparatus 20.

The guide member 46 extends from the clip 38. The guide member 46 is sized, shaped and positioned to position the string hand 32, arm 34 and wrist 36 of the instrument player such that the string hand 32, arm 34 and wrist 36 are substantially straight, and such that the string hand 32, arm 34 and wrist 36 avoid contact with the instrument body 26 and the portion of the instrument neck 24 near the instrument body 26 when the fingers 37 of the player's string hand 32 are positioned for playing the instrument 22 by depressing one or more strings 30 from the first position 50 for playing the instrument 22. This configuration of the guide member 46 and hand 32, arm 34 and wrist 36 alignment is illustrated within FIG. 2. Note the linear alignment of the hand 32, arm 34 and wrist 36. Also, note that the hand 32, arm 34 and wrist 36 avoid contact with the instrument body 26. They also avoid contact with the portion of the instrument neck 24 near the instrument body 26. FIG. 2 shows the fingers 37 of the players string hand 32 positioned for playing the instrument 22 by depressing one or more of the strings 30. The hand 32 and fingers 37 are in the first position for playing the instrument.

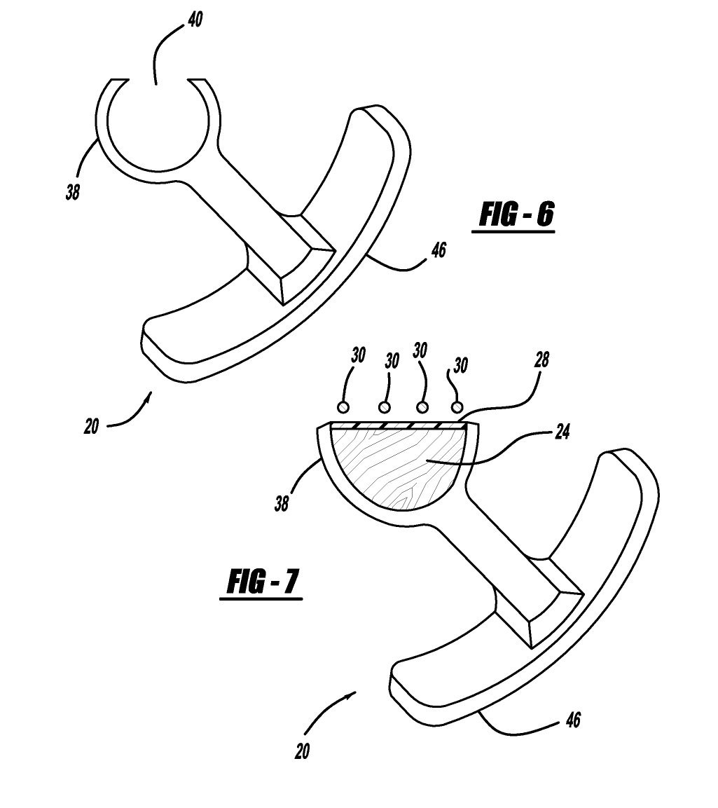

The guide member 46 should be generally radiused toward the body 26 of the instrument 22. The generally radiused portion 48 of the guide member 46 is shown in FIG. 2 and FIG. 5. The guide member 46 substantially fits the palm of the string hand 32 of the player. Thus the guide member 46 tends to conform to the shape of the palm of the player when the player is playing the instrument 22. I have found the preferred radius of the guide member 46 to be approximately 2.125 inches.

The guide member 46 may be extended from the clip 38 by a strut 52. Alternatively, the strut 52 may be considered to be integral to and a part of either the guide member 46 or the clip 38. The term strut 52 is intended to include the weblike structure, shown within FIGS. 2-7, which is positioned between the terminal end of the guide member 46 and the clip 38. The term strut 52 is also intended to include a bar like structure which attaches the radiused portion 48 of the guide member 46 to the clip 38.

I have found that when using a bar like strut 52 to attach a radiused portion 48 of a guide member 46 to a clip 38 that the angle between the strut 52 and the longitudinal section of the clip 38 to which the strut 52 is attached is preferably an acute angle of approximately 45°. Also preferably, an acute angle of approximately 45° should be formed between the longitudinal axis of the strut 52 and a plane perpendicular to the body 26 of the instrument 22 which cuts through the longitudinal axis of the instrument neck 24. This strut angle is defined on the side of the plane distal to the player's chin when the instrument 22 is being played by the player. The angles described will properly position the radiused portion 48 of the guide member 46 and the strut 52.

The apparatus 20 is intended to be used to teach a student how to play an unfretted stringed instrument, such as a violin 22. More specifically, the apparatus 20 will assist in teaching the student proper string hand 32, arm 34, wrist 36 and finger 37 positioning. First, an apparatus 20 as described is selected. The apparatus 20 is attached to the neck 24 of the instrument 22 such that the string hand 32, arm 34 and wrist 36 of the instrument player are substantially straight, and such that the string hand 32, arm 34 and wrist 36 avoid contact with the instrument body 26 and the portion of the instrument neck 24 near the instrument of body 26 when the fingers 37 of the player's string hand 32 are correctly positioned for playing the instrument 22 by depressing one or more strings 30 from the first position 50 for playing the instrument 22. The student is advised as to correct finger 37, hand 32, wrist 36 and arm 34 positioning when playing the instrument 22. Proper positioning is illustrated within FIG. 2. The student is also advised as to incorrect finger 37, hand 32, wrist 36 and arm 34 positioning when playing instrument 22. The wrist 36 should not be bent, as shown in FIG. 1. After the apparatus 20 is attached and the student is advised as to correct and incorrect hand, arm, wrist positioning, the student is instructed to play the instrument 22. When the student plays the instrument 22 the student will receive tactile feedback from the apparatus 20 if the student uses incorrect finger 37, hand 32, wrist 36 or arm 34 positioning. In other words, a student employing incorrect positioning will feel interference from the apparatus 20. On the other hand, if the student employees correct positioning, the student will not feel interference from the apparatus 20.

The apparatus 20 may also be used to teach the proper playing of vibrato tones. When playing vibrato the string fingers 37 and string hand 32 move cyclically toward and away from the scroll end of the neck 24. If the cyclical movement of the hand 32, arm 34 or wrist 36 invade the area protected by a properly attached apparatus 20, the player is incorrectly playing vibrato. The apparatus 20 will assist in training the player to avoid such improper movements.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An apparatus for teaching the playing of an unfretted stringed instrument having a neck connected to a body, a fingerboard overlaying the neck and body, and strings extending along the fingerboard, said apparatus comprising:
(a) clip sized and shaped to be releasably attachable to a portion of the instrument neck near the instrument body, said clip being generally cylindrical in shape with a cutout extending along the length of the clip for receiving the neck of the instrument such that the clip will surround a portion of the instrument neck and fingerboard delimited by the fingerboard when the clip is attached to a portion of the instrument neck near the instrument body; and
(b) a guide member extending from the clip, said guide member being sized, shaped and positioned to position the string hand, arm and wrist of the instrument player such that the string hand, arm and wrist are substantially straight, and such that the string hand, arm and wrist avoid contact with the instrument body and the portion of the instrument neck near the instrument body when the fingers of the player's string hand are positioned for playing the instrument by depressing one or more strings from the first position for playing the instrument.

2. (canceled)

3. An apparatus for teaching the playing of an unfretted stringed instrument having a neck connected to a body, a fingerboard overlaying the neck and body, and strings extending along the fingerboard, said apparatus comprising:
(a) a clip sized and shaped to be releasably attachable to a portion of the instrument neck near the instrument body, said clip being generally cylindrical in shape with a cutout extending along the length of the clip for receiving the neck of the instrument, the width of the cutout near a body end of the clip being narrower than the width of the cutout at the other end of the clip such that the clip will surround a portion of the instrument neck and fingerboard delimited by the fingerboard when the clip is attached to a portion of the instrument neck near the instrument body; and
(b) a guide member extending from the clip, said guide member being sized, shaped and positioned to position the string hand, arm and wrist of the instrument player such that the string hand, arm and wrist are substantially straight, and such that the string hand, arm and wrist avoid contact with the instrument body and the portion of the instrument neck near the instrument body when the fingers of the player's string hand are positioned for playing the instrument by depressing one or more strings from the first position for playing the instrument.

4. The apparatus for teaching the playing of an unfretted stringed instrument of claim 3, wherein the guide member is extended from the clip by a strut and wherein the guide member is generally radiused toward the body of the instrument such that the guide member substantially fits the palm of the string hand of the player when the clip is attached to the neck of the instrument and the fingers of the string hand of the player are positioned upon one or more strings of the instrument.

5. The apparatus for teaching the playing of an unfretted stringed instrument of claim 4, wherein the angle between the strut and the longitudinal section of the clip to which the strut is attached is an acute angle and wherein an acute angle is formed between the longitudinal axis of the strut and a plane perpendicular to the body of the instrument through the longitudinal axis of the instrument neck, said strut angle being defined on the side of the plane distal to the player's chin when the instrument is being played by the player.

6. A method for teaching a student the playing of an unfretted stringed instrument having a neck connected to a body, a fingerboard overlaying the neck and body, and strings extending along the fingerboard, said method comprising:
(a) selecting an apparatus for teaching the playing of an unfretted stringed instrument having a neck connected to a body, a fingerboard overlaying the neck and body, and strings extending along the fingerboard, said apparatus comprising:
(i) a clip sized and shaped to be attachable to a portion of the instrument neck near the instrument body; and
(ii) a guide member extending from the clip, said guide member being sized, shaped and positioned to position the string hand, arm and wrist of the instrument player such that the string hand, arm and wrist are substantially straight, and such that the string hand, arm and wrist avoid contact with the instrument body and the portion of the instrument neck near the instrument body when the fingers of the player's string hand are positioned for playing the instrument by depressing one or more strings;
(b) attaching the apparatus to the neck of the instrument such that the string hand, arm and wrist of the instrument player are substantially straight, and such that the string hand, arm and wrist avoid contact with the instrument body and the portion of the instrument neck near the instrument body when the fingers of the player's string hand are positioned for playing the instrument by depressing one or more strings from the first position for playing the instrument;
(c) advising the student as to correct finger, hand, wrist and arm positioning when playing the instrument;
(d) advising the student as to incorrect finger, hand, wrist and arm positioning when playing the instrument; and
(e) having the student play the instrument and receive tactile feedback from the apparatus when the student uses incorrect finger, hand, wrist or arm positioning while playing the instrument.

7. The apparatus for teaching the playing of an unfretted stringed instrument of claim 1, wherein the instrument is a violin.

8. (canceled)

9. The apparatus for teaching the playing of an unfretted stringed instrument of claim 3, wherein the instrument is a violin.

10. The apparatus for teaching the playing of an unfretted stringed instrument of claim 4, wherein the instrument is a violin.

11. The apparatus for teaching the playing of an unfretted stringed instrument of claim 5, wherein the instrument is a violin.

12. The method for teaching the playing of an unfretted stringed instrument of claim 6, wherein the instrument is a violin.
